(19) United States
(12) Patent Application Publication
(10) Pub. No.: US 2008/0024624 A1
(43) Pub. Date: Jan. 31, 2008

(54) Photographing apparatus and exposure control method

(75) Inventor: Satoshi Okamoto, Asaka-shi (JP)

Correspondence Address: BIRCH STEWART KOLASCH & BIRCH, PO BOX 747, FALLS CHURCH, VA, 22040-0747, US

(73) Assignee: FUJIFILM Corporation

(21) Appl. No.: 11/819,437

(22) Filed: Jun. 27, 2007

(30) Foreign Application Priority Data
Jul. 25, 2006 (JP) 2006-202595

(51) Int. Cl. H04N 5/235; G03B 7/00; G06K 9/46

(52) U.S. Cl. 348/229.1; 382/190; 396/213; 348/E05.034

(57) ABSTRACT

The present invention provides a photographing apparatus comprising: a photographing device which photographs an image of a photographic subject; a display device which displays a photographic image photographed by the photographing device; a face detection device which detects a face of a person of the photographic subject from the photographic image; a photographing mode changing device which changes a photographing mode between a manual mode that a user controls exposure manually and another mode that exposure is controlled automatically; an exposure control device which controls exposure by executing an exposure calculation based on information on a detected face if the face is detected from the photographic image in case that the photographing mode is set to the manual mode; and a display control device which controls a display of the display device based on a result of the exposure calculation.

### BACKGROUND OF THE INVENTION

1. Field of the Invention

The present invention relates to a photographing apparatus and an exposure control method, specifically, to a technology for controlling exposure.

2. Description of the Related Art

Japanese Patent Application Laid-Open No. 2003-57713 discloses a photographing apparatus which can select which of an automatic exposure control and a manual exposure control is executed until a photographing start operation unit is operated even in such a state that a manual exposure control mode is set up.

In the above Japanese Patent Application Laid-Open No. 2003-57713, while the automatic exposure control can be selected in case of the manual exposure control mode, an exposure control adjusted to a specific photographic subject can not be executed in case of the manual exposure control mode.

The present invention has been made in consideration of such circumstances, an object of the present invention is to provide a photographing apparatus and an exposure control method which can execute an exposure control adjusted to a specific photographic subject in case of the manual exposure control mode.

### SUMMARY OF THE INVENTION

In order to solve the above problem, a photographing apparatus according to a first aspect of the present invention is characterized by comprising a photographing device which photographs an image of a photographic subject, a display device which displays a photographic image photographed by the photographing device, a face detection device which detects a face of a person in the photographic subject from the photographic image, a photographing mode changing device which changes a photographing mode between a manual mode that a user controls exposure manually and another mode that exposure is controlled automatically, an exposure control device which controls exposure by executing an exposure calculation based on information on a detected face if the face is detected from the photographic image in case that the photographing mode is set up to the manual mode, and a display control device which controls a display of the display device based on a result of the exposure calculation.

According to the invention related to the first aspect, a display of the display device can be controlled by executing an exposure control adjusted to a face area in case of the manual mode.

The invention related to a second aspect of the present invention is characterized in that in the photographing apparatus according to the first aspect, the exposure control device controls exposure in case that a through-image is photographed based on the result of the exposure calculation.

According to the invention related to the second aspect, a framing can be executed while confirming a face area under an appropriate exposure control by executing a through-image display as executing an exposure control adjusted to the face area in case of the manual mode.

The invention related to a third aspect of the present invention is characterized in that in the photographing apparatus according to the first or second aspect, the display control device causes the display device to display an exposure indicator for a criterion of a manual exposure control operation, and the exposure indicator reflects the result of the exposure calculation.

According to the invention related to the third aspect, the exposure adjusted to a face of a photographic subject can be achieved even in case of the manual mode by using the exposure indicator designating a difference between the exposure obtained from a shutter speed and an iris value which are set up manually and the appropriate exposure adjusted to a face of a photographic subject in case of the manual mode.

The invention related to a fourth aspect of the present invention is characterized in that in the photographing apparatus according to the first to the third aspect, the display control device executes a display emphasizing a face detected by the face detection device or a display clearing up a position of a face in a display screen when the photographing mode is set up to the other mode, and does not execute the display emphasizing a face detected by the face detection device or the display clearing up a position of a face in the display screen when the photographing mode is set up to the manual mode.

That is, because many users using the manual mode are advanced-level users who are skilled in an operation of an electronic camera, it eliminates the inconvenience of the users not to display a face frame in case of the manual mode.

The invention related to a fifth aspect of the present invention is characterized by further including a face detection control device which sets up ON/OFF of a face detection processing by the face detection device in the photographing apparatus according to the first to the fourth aspect.

According to the invention related to the fifth aspect, it is possible to select whether or not the exposure control based on the face detection is executed by controlling ON/OFF of the face detection in case of the manual mode.

An exposure control method related to a sixth aspect of the present invention is characterized by including a photographing step which photographs an image of a photographic subject, a display step which displays the photographed photographic image on a display device, a face detection step which detects a face of a person of the photographic subject from the photographic image, a photographing mode changing step which changes a photographing mode between the manual mode that a user controls exposure manually and another mode that exposure is controlled automatically, an exposure control step which controls exposure by executing a exposure calculation based on information on a detected face if the face is detected from the photographic image in case that the photographing mode is set up to the manual mode, and a display control step which controls a display of the display device based on a result of the exposure calculation.

The invention related to a seventh aspect of the present invention is characterized in that in the exposure control method according to the sixth aspect, the exposure control step controls exposure in case that a through-image is photographed based on the result of the exposure calculation.

The invention related to an eighth aspect of the present invention is characterized in that in the exposure control method according to the sixth or the seventh aspect, at the display control step the display device is caused to display an exposure indicator for a criterion of a manual exposure control operation, and the exposure indicator reflects the result of the exposure calculation.

The invention related to a ninth aspect of the present invention is characterized in that in the exposure control method according to the sixth to the eighth aspect, the display control step executes a display emphasizing a face detected at the face detection step or a display clearing up a position of a face in a display screen when the photographing mode is set up to the other mode, and does not execute the display emphasizing the face detected at the face detection step or the display clearing up the position of the face in the display screen when the photographing mode is set up to the manual mode.

The invention related to a tenth aspect of the present invention is characterized by further including a face detection control step which sets up ON/OFF of a face detection processing at the face detection step in the exposure control method according to the sixth to the ninth aspect.

According to the present invention, a display of the display device can be controlled by executing an exposure control adjusted to a face area in case of the manual mode.

### BRIEF DESCRIPTION OF THE DRAWINGS

FIGS. 1A and 1B are diagrams illustrating an external appearance of a photographing apparatus according to an embodiment of the present invention;

FIG. 2 is a block diagram illustrating an electric configuration of a photographing apparatus 10;

FIG. 3 is a flowchart illustrating a flow of a processing of an exposure control according to the first embodiment of the present invention;

FIG. 4 is a flowchart illustrating a flow of a processing of an exposure control according to the second embodiment of the present invention; and

FIGS. 5A and 5B are diagrams illustrating an example of a through-image display.

### DETAILED DESCRIPTION OF THE PREFERRED EMBODIMENTS

Preferred embodiments of a photographing apparatus and an exposure control method according to the present invention will be described below according to the appended drawings.

### First Embodiment

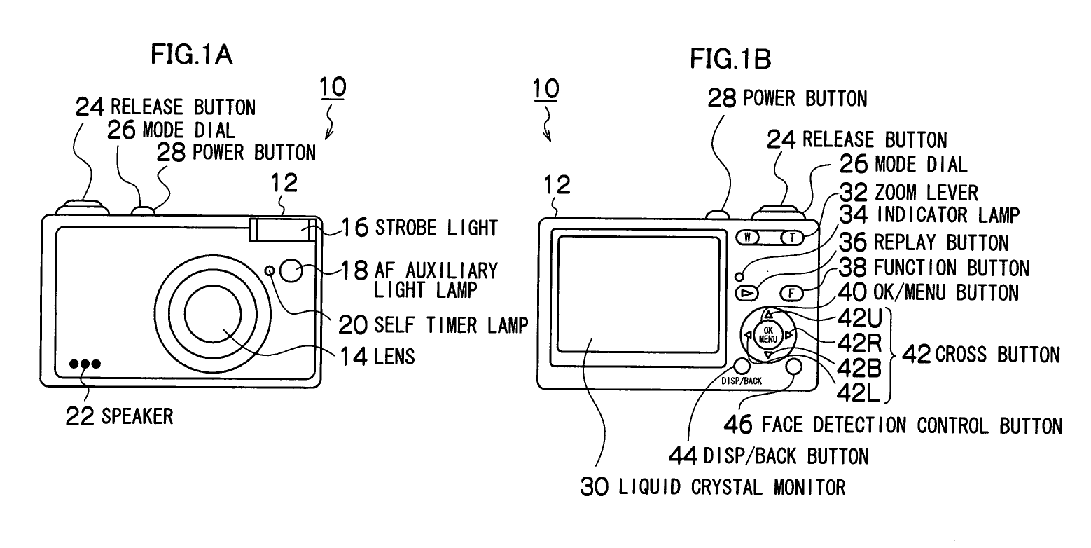

FIG. 1A is a diagram illustrating a front external appearance of a photographing apparatus according to an embodiment of the present invention, FIG. 1B is a diagram illustrating the back external appearance. A photographing apparatus 10 is an electronic camera providing functions of recording and replaying of a still image and a moving image. A camera body 12 of the photographing apparatus 10 is formed in a flat and square box. As illustrated in FIG. 1A, a photographing lens 14, a strobe light 16, AF auxiliary light lamp 18, a self timer lamp 20, and a speaker 22 are installed in the front side of the camera body 12, and a release button 24, a mode dial 26, and an power button 28 are installed in the upper side. As illustrated in FIG. 1B, a liquid crystal monitor 30, a zoom lever 32, an indicator lamp 34, a replay button 36, a function button 38, an OK/MENU button 40, a cross button 42, a DISP/BACK button 44, and a face detection control button 46 are installed in the back side of the camera body 12.

The power button 28 functions as a button for turning on/off power of the photographing apparatus 10.

The photographing lens 14 is configured with a collapsible zoom lens, and is pushed out from the front side of the camera body 12 by turning on power of the photographing apparatus 10. Then, it sinks into the camera body 12 by turning off power of the photographing apparatus 10.

The release button 24 is configured with a double stroke type button including so-called [half stroke] (i.e. S1) and [full stroke] (i.e. S2), AF (Auto Focus) and AE (Auto Exposure) are caused to function by [half stroke], and a photographing is executed by [full stroke].

The liquid crystal monitor 30 installed in the back side of the camera body 12 is used as a replay monitor of a photographed image, and is used as an electronic view finder in case of photographing. The DISP/BACK button 44 functions as a button for changing ON/OFF of this electronic view finder. The liquid crystal monitor 30 is also utilized as a display screen for a user interface, and displays menu information and information such as a selection item and a setting content if it is needed. Meanwhile, instead of the liquid crystal monitor 30, a display apparatus of another method such as an organic EL (electro-luminescence) can be also used.

The photographing apparatus 10 has two modes of a photographing mode for photographing an image and a replay mode for replaying an image. The replay button 36 functions as a button for changing from the photographing mode to the replay mode, and an operation mode is changed from the photographing mode to the replay mode by executing a push operation for the replay button 36 in case of the photographing mode. Meanwhile, a changing from the replay mode to the photographing mode is executed by pushing the release button 24 in the half stroke in case of the replay mode.

The indicator lamp 34 functions as a lamp for displaying operation states (e.g. AF locking, image recording, charging).

The mode dial 26 functions as a switch for changing the photographing mode of the photographing apparatus 10, the photographing mode is changed by the setting positions to a scene position mode for photographing by optimizing focus and exposure according to scene positions (e.g. natural photo, person, landscape, sport, night scene, underwater photographing, close up (flower, etc.), or text photographing), a auto mode for setting focus and exposure automatically, a manual mode which enables manual focus and exposure setting, or a moving image photographing mode.

The zoom lever 32 is configured with a seesaw button which is swing-free in the left-right direction, and functions as an operation button in case of a zoom operation. That is, under the photographing mode, if this zoom lever 32 is operated in the right direction, the zoom is operated in the telephoto direction, and if it is operated in the left direction, the zoom is operated in the wide direction. Under the replay mode, for the zoom lever 32, if the zoom lever 32 is operated in the right direction, the enlarged replay image is displayed, and if it is operated in the left direction, the reduced replay image is displayed.

OK/MENU button 40 functions as a button for directing a display of a menu screen, and if this OK/MENU button is pushed, the menu screen is displayed in the liquid crystal monitor 30. In addition, this OK/MENU button 40 functions as a button for directing for fixing and executing of operation for an item selected from the menu screen, the DISP/BACK button 44 functions as a button for directing for canceling the item selected from the menu screen and returning by one state.

The cross button 42 is, as illustrated in FIG. 1B, a seesaw button which is swing-free in the left-right and up-down direction, and is formed surrounding the OK/MENU button 40. The cross button 42 is configured with a upper button 42U, a bottom button 42B, a left button 42L, and a right button 42R, selects a replay through-image in case of the replay mode, and functions as a cursor shift key which moves a cursor designating a selection state of items in the menu screen. That is, under the replay mode, the left button 42L functions as a frame return button (button directing so that an image of one frame before is displayed), and the right button 42R functions as a frame advance button (button directing so that an image of one frame after is displayed).

The left button 42L functions as a macro mode button for changing ON/OFF of a macro function (close up function) under the still image or the moving image photographing mode, and if the left button 42L is pushed, the macro function is turned ON or OFF.

The right button 42R functions as a button for changing a flash mode under the still image or the moving image photographing mode, and if the right button 42R is pushed, the flash mode is set to each mode of flash firing/firing prohibition.

The upper button 42U functions as a one frame erase button for erasing one frame of image under the replay mode.

The bottom button 42B functions as a button for setting conditions of a self timer photographing under the photographing mode, every time the bottom button 42B is pushed in case of the photographing mode, ON/OFF of a self timer is changed.

The function button 38 functions as a button for setting number of recording pixels, photographing sensitivity, and color tone in case of the photographing mode, and functions as a button for setting a print reservation in case of the replay mode.

The face detection control button 46 functions as a button for setting ON/OFF of face detection in case of the photographing mode. Meanwhile, an icon, etc. for designating ON/OFF of face detection may be displayed in the liquid crystal 30 in case of the photographing mode.

### [Electrical Configuration of the Photographing Apparatus 10]

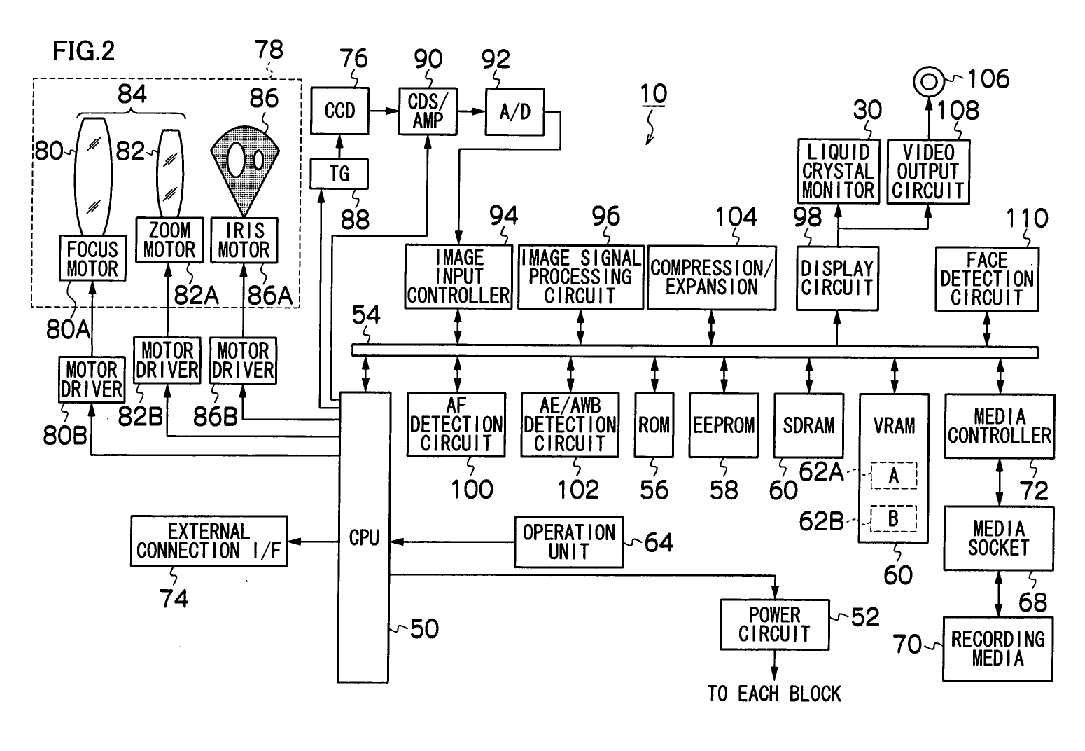

FIG. 2 is a block diagram illustrating an electrical configuration of the photographing apparatus 10. An operation of the whole photographing apparatus 10 is controlled totally by a central processing unit (CPU) 50. The CPU 50 functions as a control device which controls this camera system according to the prescribed program, and functions as a calculation device which executes various calculations such as automatic exposure (AE) calculation, automatic focus adjustment (AF) calculation, and white balance (WB) adjustment calculation. An power circuit 52 supplies power to each block of this camera system.

A ROM (Read Only Memory) 56 and an EEPROM (Electronically Erasable and Programmable Read Only Memory) 58 are connected to the CPU 50 through a bus 54. The ROM 56 stores programs executed by the CPU 50 and various data which is necessary for control, and the EEPROM 58 stores CCD pixel defect information, and various constants/information regarding a camera operation, etc.

A memory (SDRAM, Synchronous Dynamic Random Access Memory) 60 is utilized as a developing area of programs and a calculation work area of the CPU 50, and is utilized as a temporary storage area of image data and sound data. A VRAM (Video Random Access Memory) 62 is a temporary storage memory of image data only, and includes A area 62A and B area 62B. Meanwhile, the memory 60 and the VRAM 62 can be combined to use.

The photographing apparatus 10 includes an operation unit 64 including operation parts such as the release button 24, the mode dial 26, the power button 28, the zoom lever 32, the replay button 36, the function button 38, the OK/MENU button 40, the cross button 42, the DISP/BACK button 44, and the face detection control button 46. Signals from such various operation parts are inputted to the CPU 50, and the CPU 50 controls each circuit of the photographing apparatus 10 based on the inputted signals, and executes, for example, a lens driving control, a photographing operation control, an image processing control, a recording/replay control of image data, and a display control of the liquid crystal monitor 30, etc.

The photographing apparatus 10 has a media socket (media installation unit) 68, a recording media 70 can be installed in the media socket 68. A form of the recording media 70 is not limited specifically, and various media such as a semiconductor memory card which xD Picture Card® and Smart Media® are representative of, a portable small hard disk, a magnetic disk, an optical disk, and an magneto optical disk can be used. A media controller 76 executes a prescribed signal conversion for transmitting and receiving input/output signals which are suitable to the recording media 70 installed in the media socket 68.

In addition, the photographing apparatus 10 has an external connection interface unit (external connection I/F) 74 as a communication device which connects to an external unit such as a personal computer. The photographing apparatus 10 can transmit and receive data with the external unit by connecting the photographing apparatus 10 and the external unit by using USB cables (not illustrated), etc. Furthermore, a communication method is not limited to USB, but another communication method such as IEEE1394 and Blue tooth® may be applied.

### [Photographing Mode]

First, the photographing mode will be described. In case of the photographing mode, an imaging unit including a color CCD solid-state image sensor 76 (hereinafter, referred to as CCD 76) is supplied with power to be able to photograph.

A lens unit 78 is an optical unit which includes a photographing lens 84 including a focus lens 80 and a zoom lens 82, and a mechanical shutter 86 doubling as an iris. Focusing of the photographing lens 84 is executed by moving the focus lens 80 with a focus motor 80A, and zooming is executed by moving the zoom lens 82 with a zoom motor 82A. The focus motor 80A and the zoom motor 82A are driven and controlled by a focus motor driver 80B and a zoom motor driver 82B, respectively. The CPU 50 outputs a control signal to the focus motor driver 80B and the zoom motor driver 82B to control them.

An iris 86 is configured with a so-called turret-type iris, and rotates a turret plate which is formed with iris holes of F2.8 to F8 to change an iris value (F value). This iris 86 is driven by an iris motor 86A. The iris motor 86A is driven and controlled by an iris motor driver 86B. The CPU 50 outputs a control signal to the iris motor driver 86B to control it.

Light passing through the lens unit 78 is focused on a photo-receiving surface of the CCD 76. Many photodiodes (photo-receiving element) are arrayed in two-dimension on the photo-receiving surface of the CCD 76, original-color filters of red (R), green (G), and blue (B) corresponding to each photodiode are placed in a prescribed array configuration. The CCD 76 has an electronic shutter function which controls charge accumulation time (shutter speed) of each photodiode. The CPU 50 controls the charge accumulation time of the CCD 76 through a timing generator (TG) 88. The, CPU 50 controls electric potential of OFD (Overflow Drain) for the CCD 76, and adjusts an upper limit value of signal charge accumulated in the photodiodes forming the CCD 76.

A photographic subject image which is focused on a photo-receiving surface of the CCD 76 is converted by each photodiode to the amount of signal charge corresponding to the amount of incident light. Signal charge accumulated in each photodiode is read in order as a voltage signal (image signal) which corresponds to the signal charge based on driving pulses (read pulse, vertical transfer clock, and horizontal transfer clock) provided from TG 88 according to a direction of the CPU 50.

Signal outputted from the CCD 76 is transferred to an analog processing unit (CDS/AMP) 90, and R, G, B signals of each pixel is processed in sample-hold method (correlated double sampling processing), and after amplified, is added to an A/D converter 92. Dot sequential R, G, B signals which are converted to digital signals by the A/D converter 92 are stored in a memory 60 through an image input controller 94.

An image signal processing circuit 96 processes the R, G, B signals which are stored in a memory 60 according to a direction of the CPU 50. That is, the image signal processing circuit 96 functions as an image processing device which includes a synchronization circuit (a processing circuit which corrects spatial differences of color signals coming from color filter array of a single plate CCD and carries out a synchronous conversion of the color signals), a white balance adjustment circuit, a gamma correction circuit, an outline correction circuit, a brightness and color difference signal generation circuit, etc. and executes a prescribed signal processing utilizing the memory 60 according to commands from the CPU 50.

RGB image data inputted to the image signal processing circuit 96 is converted to brightness signal (Y signal) and color difference signal (Cr, Cb signal) and the prescribed processing such as a gamma correction is executed in the image signal processing circuit 96. The image data processed in the image signal processing circuit 96 is stored in the VRAM 62.

When photographic image is monitor-outputted to the liquid crystal monitor 30, the image data is read from the VRAM 62 to be transferred to a display circuit 98 through the bus 54. The display circuit 98 converts the inputted image data to video signal of the prescribed method for display (e.g. color composite image signals of NTSC method) to output it to the liquid crystal monitor 30.

A face detection circuit 110 executes a face detection processing for the image data processed by the image signal processing circuit 96 when the face detection is ON. The face detection method refers to, for example, a method which retrieves pixels from an original image which have a color which is close to a color designated as a skin color, and detects the retrieved area as a face area. This face detection processing is executed by determining, for example, whether or not color of each pixel is within the range defined as the skin color on a color space from information on skin color sampled previously on the color space for distinguishing the skin color from other colors. That is, the face detection circuit 110 calculates an evaluation value of face-likeness (face-likeness score) for every skin color area detected from the image, and outputs this face-likeness score to the CPU 50. Meanwhile, the face-likeness score is a parameter which designates whether or not the area detected by the face detection circuit 110 is a face area, and is calculated according to, for example, degree of skin color, etc. The CPU 50 determines that the skin color area whose face-likeness score is the prescribed value or more is a face area, and controls the liquid crystal monitor 30 to display the face area of the image. The face detection circuit 110 outputs information on position and size of the skin color area detected by the above face detection processing to the CPU 50. The CPU 50 controls the display circuit 98 to execute a necessary display to the liquid crystal monitor 30.

An image data which is a frame of image is rewritten to A area 62A and B area 62B of the VRAM 62 alternately by the image signals outputted from the CCD 76. In A area 62A and B area 62B of the VRAM 62, the written image data is read from the other area than the area where image data is being rewritten. The image data in the VRAM 62 is rewritten periodically in this way, and the image signals generated from the image data are supplied to the liquid crystal monitor 30, so that the image which is being photographed is display in real time on the liquid crystal monitor 30. A photographer can confirm the photographic image with the image displayed in the liquid crystal monitor 30 (preview image).

If the release button 24 is pushed by the half stroke and S1 is turned on, the photographing apparatus 10 starts a processing of AE and AF. That is, the image signals outputted from the CCD 76 are inputted to an AF detection circuit 100 and an AE/AWB detection circuit 102 through an image input controller 94 after A/D conversion.

The AE/AWB detection circuit 102 includes a circuit which divides one screen to plural divided areas (e.g. 8×8, 16×16) and accumulates RGB signals for every divided area, and provides the accumulated value to the CPU 50. The CPU 50 detects brightness of a photographic subject (photographic subject brightness) based on the accumulated value obtained from the AE/AWB detection circuit 102, and calculates an exposure value which is suitable to photographing (photographing EV value). The CPU 50 determines an iris value and a shutter speed according to the calculated exposure value and the prescribed program line diagram, and controls an electronic shutter and an iris of the CCD 76 according to this to obtain an appropriate amount of exposure.

The AE/AWB detection circuit 102 executes the exposure control including detection result of a face area in case that the face detection is ON. Meanwhile, the exposure control will be described in details below.

The AE/AWB detection circuit 102 calculates an average accumulated value of each color of RGB signals for every divided area, and provides the calculated result to the CPU 50 in case of the automatic white balance adjusting. The CPU 50 obtains an accumulated value of R, an accumulated value of B, and an accumulated value of G, calculates ratio of R/G and B/G for every divided area, discriminates the kind of a light source based on a distribution, etc. in a color space whose coordinate axes are R/G axis and B/G axis of such R/G value and B/G value, controls a gain value (white balance gain) for R, G, B signals of the white balance adjustment circuit according to the discriminated kind of a light source, and corrects a signal of each color channel.

The contrast AF which moves a focus lens 80 so that high frequency component of the G signal of the image signals is maximized locally is applied to the AF control of the photographing apparatus 10. That is, the AF detection circuit 100 includes a high pass filter which causes only the high frequency component of the G signal to pass, an absolute value processing unit, an AF area extraction unit which extracts a signal in a focus target area which has been set previously in a screen (e.g. central part of a screen), and a accumulation unit which accumulates an absolute value data in the AF area.

The accumulated value data calculated by the AF detection circuit 100 is outputted to the CPU 50. The CPU 50 calculates a focus evaluation value (AF evaluation value) at plural AF detection points moving the focus lens 80 by controlling the focus motor driver 80B, and determines that such a lens position that the focus evaluation value is maximized locally is a focused position. Then, the CPU 50 controls the focus motor driver 80B so as to move the focus lens 80 to the calculated focused position. Meanwhile, the calculation of the AF evaluation value is not limited to such a case that the G signal is used, but the brightness signal (Y signal) may be used.

If the release button 24 is pushed in half stroke, S1 is turned on, then the AE/AF processing is executed, and if the release button 24 is pushed in full stroke, S2 is turned on, then a photographing operation for recording is started. The image data obtained responding to that S2 is turned on is converted to the brightness/color difference signal (Y/C signal) in the image signal processing circuit 96, and is stored in the memory 60 after prescribed processing such as the gamma correction is executed.

The Y/C signal stored in the memory 60 is compressed by a compression/expansion circuit 104 according to a prescribed format, then, is recorded in the recording media 70 through a media controller 72. For example, a still image is recorded in JPEG (Join Photographic Experts Group) format, and a moving image is recorded in AVI (Audio Video Interleaving) format as Motion-JPEG image file.

### [Replay Mode]

In the replay mode, the compressed data of the last image file (image file recorded lastly) recorded in the recording media 70 is read. If the image file related to the last recorded is a still image file, this read image compressed data is expanded to non-compressed YC signal through the compression/expansion circuit 104, is converted to signal for display through the image signal processing circuit 96 and the display circuit 98, then, is outputted to the liquid crystal monitor 30. Thereby, the image content of such image file is displayed on a screen of the liquid crystal monitor 30.

It is possible to change an image file of a replay target (forward frame-advance/reverse frame-back) by operating the right button or the left button of the cross button 42 while one frame of a still image is being replayed (including the period of time during a replay of a beginning frame of a moving image). An image file at a frame-advance or frame-back position is read from the recording media 70, and the still image and the moving image are replayed and displayed in the liquid crystal monitor 30 as described above.

In case of the replay mode, if an external display such as a personal computer and a television is connected to the photographing apparatus 10 through an external interface unit, the image file recorded in the recording media 70 is processed by the display circuit 98, and is replayed and displayed in this external display.

### [Exposure Control Processing]

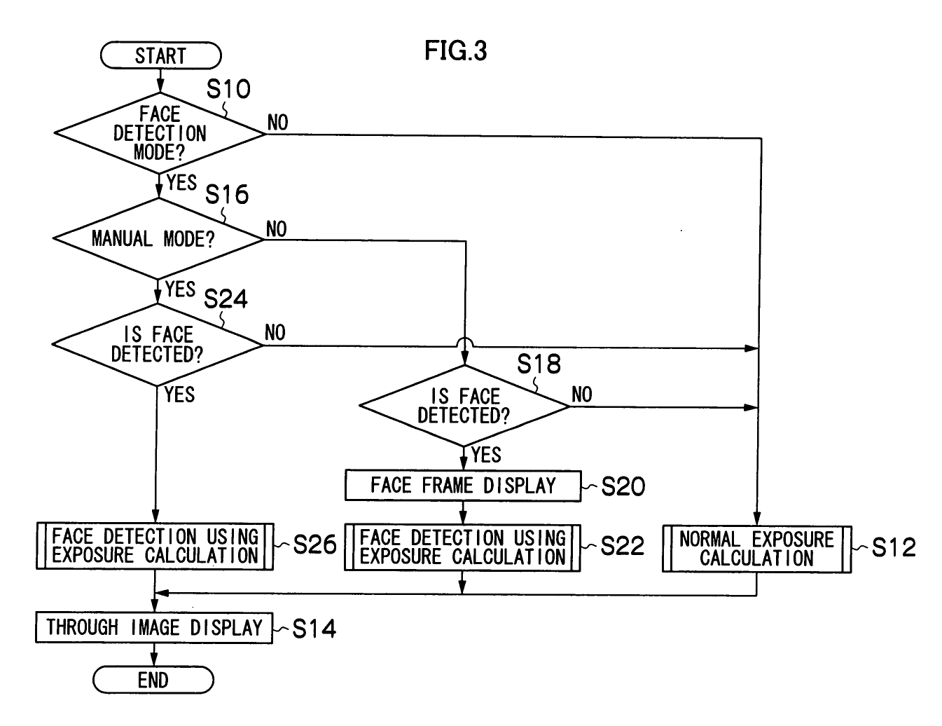

Next, an exposure control processing according to the embodiment will be described referring to a flowchart of FIG. 3. First, when power is applied to the photographing apparatus 10 and an operation mode is set to the photographing mode, in the CPU 50, a state of the face detection control button 46 is detected, and ON/OFF of the face detection mode is determined (step S1). If the face detection mode is OFF (STEP S10: No), normal exposure calculation is executed, and the exposure control based on a result of normal exposure calculation is executed (step S12). Then, under this exposure control, an image is photographed and the prescribed processing is executed, and a through-image is displayed in the liquid crystal monitor 30 (step S14).

At step S10, if the face detection mode is ON (STEP S10: Yes), next, a setting position of the mode dial 26 is detected, and it is determined whether or not the photographing mode is set to the manual mode (step S16).

At step S16, if the photographing mode is not set to the manual mode (step S16: No), an image is then photographed as a through-image and the prescribed processing is executed. Subsequently, the face detection processing is executed for the image data outputted from the image signal processing circuit 96, and it is determined whether or not a face area is detected (step S18).

At step S18, if the face area is not detected (step S18: No), normal exposure calculation is executed, and the exposure control based on a result of the normal exposure calculation is executed (step S12). Then, under this exposure control, an image is photographed, and a through-image is displayed in the liquid crystal monitor 30 (step S14).

On the other hand, if the face area is detected (step S18: Yes), a face frame is set to the detected face area (step S20). Then, the exposure calculation is executed so that an exposure of the detected face area is optimal, and the exposure control is executed based on a result of this exposure calculation (step S22). Then, under this exposure control, an image is photographed and the prescribed processing is executed, and a through-image is displayed in the liquid crystal monitor 30 (step S14). Meanwhile, at step S18, if a plurality of face areas are detected, the face frame is attached to, for example, a face area whose size is largest, a face area whose distance from the center of the image is smallest, or a face area whose degree of face-likeness is the highest value, and the exposure calculation adjusted to the face area attached with the face frame may be executed.

At step S16, if the photographing mode is set to the manual mode (step S16: Yes), next, an image is photographed as a through-image and the prescribed processing is executed. Then, the face detection processing is executed for the image data outputted from the image signal processing circuit 96, and it is determined whether or not a face area is detected (step S24).

At step S24, if the face area is not detected (step S24: No), normal exposure calculation is executed, and the exposure control based on a result of the normal exposure calculation is executed (step S12). Then, under this exposure control, an image is photographed, and a through-image is displayed in the liquid crystal monitor 30 (step S14).

On the other hand, if the face area is detected (step S24: Yes), the exposure calculation is executed so that an exposure of the detected face area is optimal, and the exposure control is executed based on a result of this exposure calculation (step S26). Then, under this exposure control, an image is photographed and the prescribed processing is executed, and a through-image is displayed in the liquid crystal monitor 30 (step S14). Meanwhile, at step S24, if a plurality of face areas are detected, the exposure calculation adjusted to, for example, a face area whose size is largest, a face area whose distance from the center of the image is smallest, or a face area whose degree of face-likeness is the highest value may be executed.

According to the first embodiment, in case of the manual mode, it is possible to execute a framing operation confirming a face area under the appropriate exposure control by executing the exposure control adjusted to a face area and executing a through-image display. If it is necessary, it is possible to execute a framing operation confirming a state of the exposure control with a through-image by turning off the face detection mode.

Meanwhile, because many users using the manual mode are advanced-level users who are skilled in an operation of an electronic camera and a display of a face frame may turn out inconvenient for them, it is preferable not to display a face frame in case of the manual mode.

### Second Embodiment

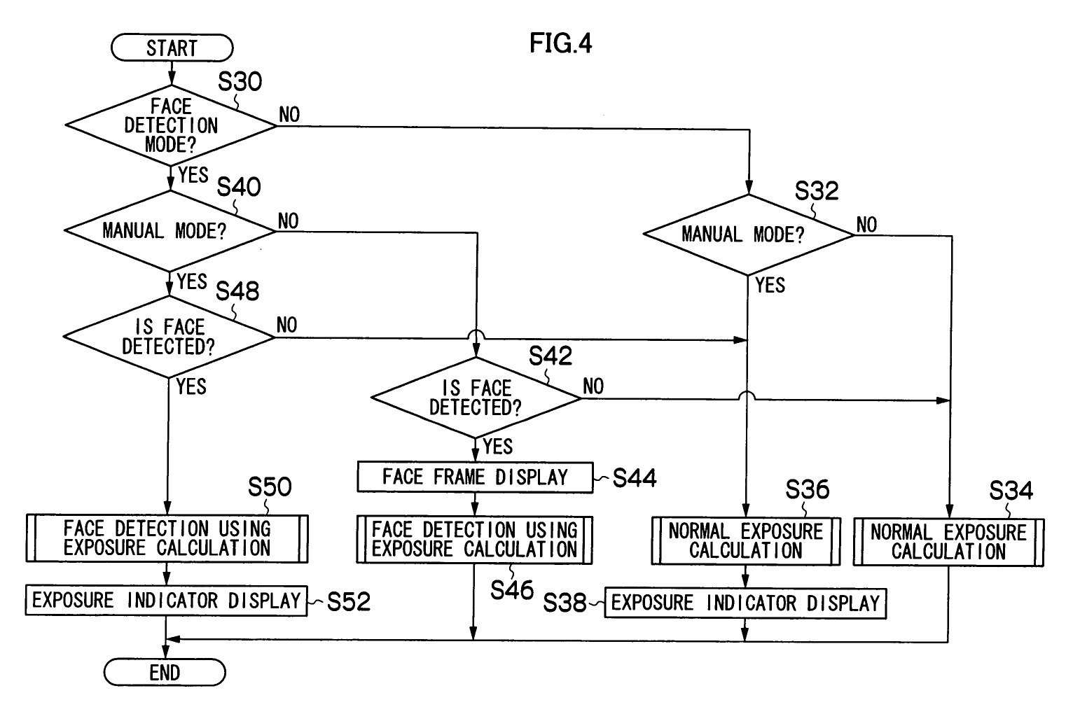

Next, an exposure control processing according to a second embodiment of the present invention will be described referring to a flowchart of FIG. 4. First, if power is applied to the photographing apparatus 10 and an operation mode is set to the photographing mode, in the CPU 50, a state of the face detection control button 46 is detected, and ON/OFF of the face detection mode is determined (step S30). If the face detection mode is OFF (STEP S30: No), next, a setting position of the mode dial 26 is detected, and it is determined whether or not the photographing mode is set to the manual mode (step S32). Then, at step S32, if the photographing mode is not set to the manual mode (step S32: No), a normal exposure calculation is executed, and the exposure control based on a result of the normal exposure calculation is executed (step S34).

And, at step S32, the photographing mode is set to the manual mode (step S32: Yes), normal exposure calculation is executed (step S36). Then, a shutter speed and an iris value which are set up manually are displayed in a through-image display screen, and a difference between the exposure obtained from the above shutter speed and iris value and the appropriate exposure adjusted to a face area is calculated, and an exposure indicator for displaying this difference is displayed in the liquid crystal monitor 30 (step S38).

At step S30, if the face detection mode is ON (STEP S30: Yes), next, it is determined whether or not the photographing mode is set to the manual mode (step S40). If the photographing mode is not set to the manual mode, for example, if it is the auto mode (step S40: No), next, an image is photographed as a through-image and the prescribed processing is executed. Then, the face detection processing is executed for the image data outputted from the image signal processing circuit 96, and it is determined whether or not a face area is detected (step S42).

At step S42, if the face area is not detected (step S42: No), a normal exposure calculation is executed, and the exposure control based on a result of the normal exposure calculation is executed (step S34). Then, under this exposure control, an image is photographed, and a through-image is displayed in the liquid crystal monitor 30.

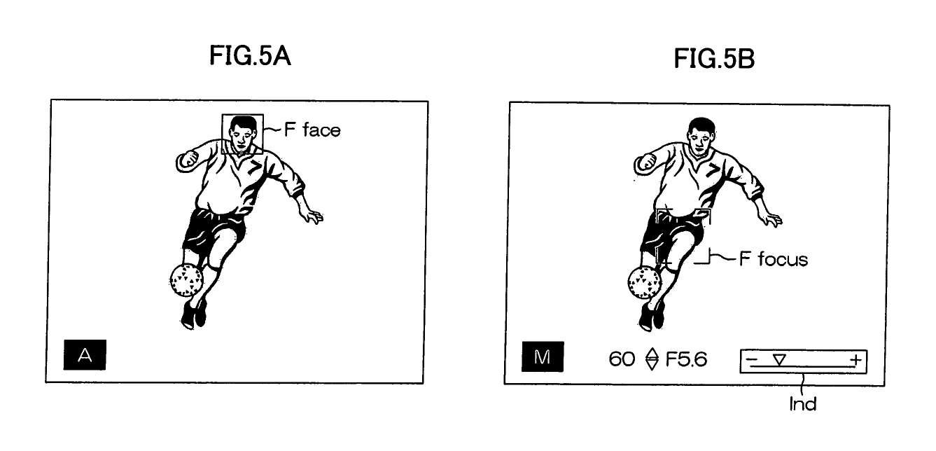

On the other hand, if the face area is detected (step S42: Yes), a face frame is set to the detected face area (step S44). Then, the exposure calculation is executed so that an exposure of the detected face area is optimal, and the exposure control is executed based on a result of this exposure calculation (step S46). Then, under this exposure control, an image is photographed, as illustrated in FIG. 5A, a face frame F_{face} is attached to the detected face area and the through-image display is executed. Meanwhile, at step S42, if a plurality of face areas are detected, the face frame F_{face} is attached to, for example, a face area whose size is largest, a face area whose distance from the center of the image is smallest, or a face area whose degree of face-likeness is the highest value, and the exposure calculation may be executed adjusting to the face area attached with the face frame F_{face}.

At step S40, if the photographing mode is set to the manual mode (step S40: Yes), next, an image is photographed as a through-image and the prescribed processing is executed. Then, the face detection processing is executed for the image data outputted from the image signal processing circuit 96, and it is determined whether or not a face area is detected (step S48).

At step S48, if the face area is not detected (step S48: No), normal exposure calculation is executed (step S36), and a through-image, a shutter speed, an iris value, and an exposure indicator are displayed in liquid crystal monitor 30 (step S38). Then, under this exposure control, an image is photographed, and a through-image is displayed in the liquid crystal monitor 30.

On the other hand, if the face area is detected (step S48: Yes), the exposure calculation is executed so that an exposure of the detected face area is optimal (step S50), as illustrated in FIG. 5B, a shutter speed and an iris value which are set up manually are displayed in a through-image display screen, and a difference between the exposure obtained from the above shutter speed and iris value and the appropriate exposure adjusted to a face area is calculated, and an exposure indicator Ind for displaying this difference is displayed in the liquid crystal monitor 30 (step S52). In FIG. 5B, F_{focus} is a focus frame designating a photographic subject which is a criterion of a focusing.

Meanwhile, because many users using the manual mode are advanced-level users who are skilled in an operation of an electronic camera and a display of a face frame may turn out inconvenient for them, it is preferable not to display a face frame in case of the manual mode.

Meanwhile, at step S48, if a plurality of face areas are detected, the exposure calculation adjusted to, for example, a face area whose size is largest, a face area whose distance from the center of the image is smallest, or a face area whose degree of face-likeness is the highest value may be executed.

According to the embodiment, in case of the manual mode, the exposure adjusted to a face area can be achieved even in case of the manual mode by using the exposure indicator designating a difference between the exposure obtained from a shutter speed and an iris value which are set up manually and the appropriate exposure adjusted to a face area.

What is claimed is:

1. A photographing apparatus, comprising:
a photographing device which photographs an image of a photographic subject;
a display device which displays a photographic image photographed by the photographing device;
a face detection device which detects a face of a person of the photographic subject from the photographic image;
a photographing mode changing device which changes a photographing mode between a manual mode that a user controls exposure manually and another mode that exposure is controlled automatically;
an exposure control device which controls exposure by executing an exposure calculation based on information on a detected face if the face is detected from the photographic image in case that the photographing mode is set to the manual mode; and
a display control device which controls a display of the display device based on a result of the exposure calculation.

2. The photographing apparatus according to claim 1, wherein the exposure control device controls exposure in case that a through-image is photographed based on the result of the exposure calculation.

3. The photographing apparatus according to claim 1, wherein
the display control device causes the display device to display an exposure indicator for a criterion of a manual exposure control operation and
the exposure indicator reflects the result of the exposure calculation.

4. The photographing apparatus according to claim 2, wherein
the display control device causes the display device to display an exposure indicator for a criterion of a manual exposure control operation and the exposure indicator reflects the result of the exposure calculation.

5. The photographing apparatus according to claim 1, wherein
the display control device executes a display emphasizing a face detected by the face detection device or a display clearing up a position of a face in a display screen when the photographing mode is set up to the other mode, and does not execute a display emphasizing a face detected by the face detection device or a display clearing up a position of a face in the display screen when the photographing mode is set up to the manual mode.

6. The photographing apparatus according to claim 2, wherein
the display control device executes a display emphasizing a face detected by the face detection device or a display clearing up a position of a face in a display screen when the photographing mode is set up to the other mode, and does not execute a display emphasizing a face detected by the face detection device or a display clearing up a position of a face in the display screen when the photographing mode is set up to the manual mode.

7. The photographing apparatus according to claim 3, wherein
the display control device executes a display emphasizing a face detected by the face detection device or a display clearing up a position of a face in a display screen when the photographing mode is set up to the other mode, and does not execute a display emphasizing a face detected by the face detection device or a display clearing up a position of a face in the display screen when the photographing mode is set up to the manual mode.

8. The photographing apparatus according to claim 1, further comprising
a face detection control device which sets ON/OFF of a face detection processing by the face detection device.

9. The photographing apparatus according to claim 2, further comprising
a face detection control device which sets ON/OFF of a face detection processing by the face detection device.

10. The photographing apparatus according to claim 3, further comprising
a face detection control device which sets ON/OFF of a face detection processing by the face detection device.

11. The photographing apparatus according to claim 5, further comprising
a face detection control device which sets ON/OFF of a face detection processing by the face detection device.

12. An exposure control method, comprising:
a photographing step which photographs an image of a photographic subject;
a display step which displays the photographed photographic image in a display device;
a face detection step which detects a face of a person of the photographic subject from the photographic image;
a photographing mode changing step which changes a photographing mode between a manual mode that a user controls exposure manually and another mode that exposure is controlled automatically;
a exposure control step which controls exposure by executing an exposure calculation based on information on a detected face if the face is detected from the photographic image in case that the photographing mode is set to the manual mode; and
a display control step which controls a display of the display device based on a result of the exposure calculation.

13. The exposure control method according to claim 12, wherein the exposure control step controls exposure in case that a through-image is photographed based on the result of the exposure calculation.

14. The exposure control method according to claim 12, wherein the display control step displays an exposure indicator for a criterion of a manual exposure control operation in the display device and
the exposure indicator reflects the result of the exposure calculation.

15. The exposure control method according to claim 13, wherein
the display control step displays an exposure indicator for a criterion of a manual exposure control operation in the display device and
the exposure indicator reflects the result of the exposure calculation.

16. The exposure control method according to claim 12, wherein
the display control step executes a display emphasizing a face detected at the face detection step or a display clearing up a position of a face in a display screen when the photographing mode is set up to the other mode, and does not execute a display emphasizing a face detected at the face detection step or a display clearing up a position of a face in the display screen when the photographing mode is set up to the manual mode.

17. The exposure control method according to claim 13, wherein
the display control step executes a display emphasizing a face detected at the face detection step or a display clearing up a position of a face in a display screen when the photographing mode is set up to the other mode, and does not execute a display emphasizing a face detected at the face detection step or a display clearing up a position of a face in the display screen when the photographing mode is set up to the manual mode.

18. The exposure control method according to claim 14, wherein
the display control step executes a display emphasizing a face detected at the face detection step or a display clearing up a position of a face in a display screen when the photographing mode is set up to the other mode, and does not execute a display emphasizing a face detected at the face detection step or a display clearing up a position of a face in the display screen when the photographing mode is set up to the manual mode.

19. The exposure control method according to claim 12, further comprising
a face detection control step which sets ON/OFF of a face detection processing at the face detection step.

20. The exposure control method according to claim 13, further comprising
a face detection control step which sets ON/OFF of a face detection processing at the face detection step.

21. The exposure control method according to claim 14, further comprising
a face detection control step which sets ON/OFF of a face detection processing at the face detection step.

22. The exposure control method according to claim 16, further comprising
a face detection control step which sets ON/OFF of a face detection processing at the face detection step.
